(19) United States
(12) Patent Application Publication
(10) Pub. No.: US 2026/0049178 A1
(43) Pub. Date: Feb. 19, 2026

(54) CROSSLINKING AGENTS AND MEDICAL HYDROGELS FORMED THEREFROM

(71) Applicant: Boston Scientific Scimed, Inc., Maple Grove, MN (US)

(72) Inventors: Rick William Dorn, Plymouth, MN (US); Nicolas Ball-Jones, Minneapolis, MN (US); Joseph Thomas Delaney, JR., Minneapolis, MN (US); Cristian Parisi, Amherst, MA (US)

(73) Assignee: Boston Scientific Scimed, Inc., Maple Grove, MN (US)

(21) Appl. No.: 19/297,524

(22) Filed: Aug. 12, 2025

Related U.S. Application Data
(60) Provisional application No. 63/682,662, filed on Aug. 13, 2024.

(51) Int. Cl. C08G 69/42; C08G 69/04; C08G 69/10; C08G 69/48

(52) U.S. Cl. CPC C08G 69/42; C08G 69/04; C08G 69/10; C08G 69/48

(57) ABSTRACT

In some aspects, the present disclosure pertains to methods that comprise (a) performing a ring-opening polymerization of one or more types of iodinated amino acid N-carboxyanhydride (NCA) monomers that comprise at least one type of iodinated amino acid NCA monomer having at least one iodinated group and at least one aromatic amine substitute in the presence of an iodinated initiator compound to produce intermediate iodinated compounds that comprise an amino acid chain having iodine groups, hydroxyl groups, and pendant amine groups covalently attached to a residue of the iodinated initiator compound and (b) converting at least some of the hydroxyl groups to amine groups or reacting amine groups of the intermediate iodinated compounds with an amine containing moiety to form final iodinated polyamide compounds that comprise an amino acid chain having iodine groups and pendant amine groups covalently attached to the residue of the iodinated initiator compound.

### CROSS-REFERENCE TO RELATED APPLICATIONS

This application claims the benefit of U.S. Provisional Patent Application Ser. No. 63/682,662 filed on Aug. 13, 2024, the disclosure of which is incorporated herein by reference.

### FIELD

The present disclosure relates to methods of forming iodinated polyamides from iodinated amino acid N-carboxyanhydride monomers using a variety of iodinated initiators, including methods of forming radiopaque polyamides using radiopaque initiators. The present disclosure also relates to the use of such iodinated polyamides as crosslinking agents for forming hydrogels, and to radiopaque hydrogels formed therefrom. Radiopaque hydrogels are useful, for example, in various medical applications.

### BACKGROUND

SpaceOAR®, a rapid crosslinking hydrogel that polymerizes in vivo within seconds, is based on a multi-arm polyethylene glycol (PEG) polymer functionalized with succinimidyl glutarate as activated end groups which further react with trilysine to form crosslinks. This product has become a very successful, clinically-used biomaterial in prostate cancer therapy. A further improvement based on this structure is that a portion the succinimidyl glutarate end groups have been functionalized with 2,3,5-triiiodobenzamide groups, providing radiopacity. This hydrogel, known by the trade name of SpaceOAR Vue®, is the radiopaque version of SpaceOAR® for prostate medical applications.

However, for various reasons alternative strategies are desired for forming iodine-labelled crosslinked hydrogels that provide enhanced radiopacity, for instance, while maintaining crosslink density per polymer molecule.

### SUMMARY

In some aspects, a method is provided. The method comprising (a) performing a ring-opening polymerization of one or more types of iodinated amino acid N-carboxyanhydride (NCA) monomers that comprise at least one type of iodinated amino acid NCA monomer having at least one iodinated group and at least one aromatic amine substitute in the presence of an iodinated initiator compound to produce intermediate iodinated compounds that comprise an amino acid chain having iodine groups, hydroxyl groups, and pendant amine groups covalently attached to a residue of the iodinated initiator compound and (b) converting at least some of the hydroxyl groups to amine groups or reacting amine groups of the intermediate iodinated compounds with an amine containing moiety to form final iodinated polyamide compounds that comprise an amino acid chain having iodine groups and pendant amine groups covalently attached to the residue of the iodinated initiator compound.

In some aspects, which can be used in conjunction with any of the above aspects, wherein the at least one iodinated group further comprises at least one iodinated aromatic group.

In some aspects, which can be used in conjunction with any of the above aspects, wherein a molar ratio of the iodinated amino acid NCA monomer to the iodinated initiator compound ranges from 2:1 to 100:1.

In some aspects, which can be used in conjunction with any of the above aspects, wherein the amino acid chain ranges from 2 to 50 amino acid in length.

In some aspects, which can be used in conjunction with any of the above aspects, wherein the pendant amine groups are a protected primary amine groups.

In some aspects, which can be used in conjunction with any of the above aspects, wherein the pendant amine groups are protected alkylamine groups.

In some aspects, which can be used in conjunction with any of the above aspects, wherein the iodinated amino acid NCA monomer includes iodinated aromatic groups.

In some aspects, which can be used in conjunction with any of the above aspects, further comprising reacting an iodinated amino acid with a phosgene or a phosgene derivative to form the iodinated amino acid NCA monomer.

In some aspects, which can be used in conjunction with any of the above aspects, wherein the iodinated amino acid is 3-Iodo-L-tyrosine, Triiodothyronine, Thyroxine, Diiodothyronine, 4-Iodo-L-phenylalanine, 3,5-Diiodotyrosine, 4-Iodo-D-phenylalanine, 3,3′-Diiodo-L-thyronine, 3′,5′,3-Triiodothyronine, or any combination thereof.

In some aspects, which can be used in conjunction with any of the above aspects, wherein the iodinated amino acid is formed by iodinating an amino acid NCA monomer.

In some aspects, which can be used in conjunction with any of the above aspects, wherein the iodinated initiator compound comprises a primary amine group or an aliphatic hydroxyl group.

In some aspects, which can be used in conjunction with any of the above aspects, wherein the iodinated initiator compound comprises (a) a primary amine group or an aliphatic group and (b) an iodinated aromatic group.

In some aspects, which can be used in conjunction with any of the above aspects, wherein the iodinated initiator compound comprises an iodinated amino acid ester.

In some aspects, which can be used in conjunction with any of the above aspects, wherein the one or more types of iodinated amino acid NCA monomers comprise a single type of iodinated amino acid NCA monomer.

In some aspects, which can be used in conjunction with any of the above aspects, wherein the hydroxyl groups and the iodine groups of the iodinated polyamide compounds comprise aromatic hydroxyl groups and iodinated aromatic groups.

In some aspects, a method is provided. The method comprising (a) forming iodinated amino acid N-carboxyanhydride (NCA) monomers by reacting an iodinated amino acid with a phosgene or phosgene derivative to form the iodinated amino acid NCA monomer, (b) performing a ring-opening polymerization of one or more types of iodinated amino acid NCA monomers that comprise at least one type of iodinated amino acid NCA monomer having at least one iodinated group and at least one aromatic amine substitute in the presence of an iodinated initiator compound to produce intermediate iodinated compounds that comprise an amino acid chain having iodine groups, hydroxyl groups, and pendant amine groups covalently attached to a residue of the iodinated initiator compound and (c) converting at least some of the hydroxyl groups to amine groups or reacting amine groups of the intermediate iodinated compounds with an amine containing moiety to form final iodinated polyamide compounds that comprise an amino acid chain having iodine groups, hydroxyl groups, and pendant amine groups covalently attached to the residue of the iodinated initiator compound.

In some aspects, which can be used in conjunction with any of the above aspects, further comprising ethoxylating at least some of the hydroxyl groups of the iodinated polyamide compounds to form iodinated multi-arm hydrophilic polymers.

In some aspects, which can be used in conjunction with any of the above aspects, wherein the iodinated multi-arm hydrophilic polymers include at least one iodinated aromatic group per arm.

In some aspects, a method of iodinating a crosslinked hydrogel is provided, the method comprising:
forming a crosslinked hydrogel having a plurality of nucleophilic groups; and
performing ring-opening polymerization of an iodinated amino acid N-carboxyanhydride (NCA) monomer having at least one iodinated group and at least one aromatic amine substitute in the presence of the cross-linked hydrogel to form an iodinated crosslinked hydrogel having iodine groups and pendant amine groups covalently attached to the residue of the iodinated amino acid NCA monomer.

In some aspects, which can be used in conjunction with any of the above aspects, further comprising functionalizing the cross-linked hydrogel with an amine group and subsequently performing the ring-opening polymerization.

The above and other aspects, embodiments, features and benefits of the present disclosure will be readily apparent from the following detailed description.

### BRIEF DESCRIPTION OF THE DRAWINGS

FIG. 1 schematically illustrates an example process for forming an iodinated polyamide compound, in accordance with an embodiment of the present disclosure.

FIG. 2 schematically illustrates an example process for forming an iodinated polyamide compound, in accordance with an embodiment of the present disclosure.

FIG. 3 schematically illustrates a process for forming a radiopaque crosslinked hydrogel product from an iodinated polyamide compound in accordance with an embodiment of the present disclosure.

FIG. 4 schematically illustrates examples of iodinated multi-arm hydrophilic polymers (e.g., star polymers) formed from an iodinated polyamide compound in accordance with an embodiment of the present disclosure.

FIG. 5A schematically illustrates a process for forming an iodinated amino acid NCA monomer, in accordance with an embodiment of the present disclosure.

FIG. 5B schematically illustrates a process for ring opening polymerization of the iodinated amino acid NCA monomer of FIG. 5A to form an iodinated polyamide compound, in accordance with an embodiment of the present disclosure.

FIG. 6A schematically illustrates a process for direct iodination of a hydrogel with an iodinated amino acid NCA monomer, in accordance with an embodiment of the present disclosure.

FIG. 6B schematically illustrates a process for forming an iodinated amino acid NCA monomer and directly iodinating a hydrogel with the iodinated amino acid NCA monomer, in accordance with an embodiment of the present disclosure.

FIG. 7 illustrates a delivery device, in accordance with an embodiment of the present disclosure.

FIG. 8 illustrates a delivery device, in accordance with another embodiment of the present disclosure.

### DETAILED DESCRIPTION

In some aspects of the present disclosure, iodinated polyamide compounds are formed from iodinated initiators and iodinated amino acid NCA monomers with fewer steps than current synthetic routes and/or can be utilized as iodinated cross-linkers or iodinated polymer to yield resultant hydrogels that exhibit improved radiopacity, as detailed herein. In some aspects of the present disclosure, the iodinated polyamide products of the present disclosure can be utilized as core initiators to form radiopaque star polymers, as detailed herein. In some aspects of the present disclosure, a cross-linked hydrogel can be directly iodinated with an iodinated amino acid NCA monomer, as described herein.

In some aspects of the present disclosure, iodinated polyamide compounds are formed by ring-opening polymerization of iodinated amino acid N-carboxyanhydrides (NCAs) using a suitable iodinated initiator, which is incorporated into a peptide chain of intermediate iodinated compounds resulting from the polymerization. Intermediate iodinated compounds in accordance with the present disclosure thus comprise an amino acid chain having iodine groups, hydroxyl groups, and pendant amine groups covalently attached to a residue of the iodinated initiator compound. Iodinated initiator residues include amine-group-containing initiator residues, iodine-group-containing residues, and hydroxyl-group-containing residues. Amino acid chains may range from 2 to 50 amino acids in length, typically, from 3 to 10 amino acids in length. Amino acid chains in accordance with the present disclosure include amino acids having aromatic iodine groups and amine pendant groups. In particular, the Iodinated initiator residues can include two or more aromatic iodine groups, four or more, six or more, eight or more, ten or more, or twelve or more aromatic iodine groups. Amino acid chains in accordance with the present disclosure include amino acids having primary amine pendant groups. In particular examples, the primary amine pendant groups are aminoalkyl groups (e.g., C₁-C₆-aminoalkyl groups, including aminomethyl, 2-aminoethyl, 3-aminopropyl, 4-aminobutyl, 5-aminopentyl and 6-aminohexyl groups, as well as isomers of the same). The length of the amino acid chain is determined from the molar ratio of the iodinated amino acid NCA monomers to the iodinated initiator compound. In general, a molar ratio of the iodinated amino acid N-carboxyanhydride (NCA) monomers to the iodinated initiator compound ranges from 2:1 to 50:1, more typically from 3:1 to 10:1.

In some embodiments, iodinated amino acid NCA polymerization is conducted using an amine-group-containing iodinated initiator based on a nucleophilic ring opening chain growth process where the polymer grows linearly with monomer conversion. In this process, when the amine reacts with the iodinated amino acid NCA monomer (iodinated NCA), the iodinated NCA's ring opens, carbon dioxide is released, and a molecule with a new primary amine end group is formed, which is available for further reaction with another iodinated NCA monomer. The iodinated initiator that is used in this process is incorporated into a resulting peptide chain. Additional information can be found, for example, in Carmen M. González-Henríquez, et al., “Strategies to Fabricate Polypeptide-Based Structures via Ring-Opening Polymerization of N-Carboxyanhydrides.” Polymers (Basel). 2017 November; 9(11): 551.

Iodinated initiators include those including iodine groups and having an unmodified amine or a silyl protected amine, for example, a trimethylsilyl protected amine.

In the present disclosure, iodinated amino acid NCA monomers are employed that contain having at least one iodinated group and at least one aromatic amine. Examples of such iodinated amino acid NCA monomers include iodinated derivatives of the iodinated amino acid tyrosine, iodinated carboxylic acid derivatives, iodinated derivatives of the amino acid phenylalanine. Particular examples of iodinated amino acids include those listed in Tables 1 and 2.

TABLE 1
Iodinated amino acids:

| Name | CAS | # I Atoms |
|---|---|---|
| 3-Iodo-L-tyrosine | 70-78-0 | 1 |
| Triiodothyronine | 6893-02-3 | 3 |
| Thyroxine | 51-48-9 | 4 |
| Diiodothyronine | 1041-01-6 | 2 |
| 4-Iodo-L-phenylalanine | 24250-85-9 | 1 |
| 3,5-Diiodotyrosine | 66-02-4 | 2 |
| 4-Iodo-D-phenylalanine | 62561-75-5 | 1 |
| 3,3′-Diiodo-L-thyronine | 4604-41-5 | 2 |
| 3′,5′,3-Triiodothyronine | 5817-39-0 | 3 |

TABLE 2
Carboxylic acid and iodine containing iodinated species:

| Name | CAS | # I atoms |
|---|---|---|
| 2-Iodobenzoic acid | 88-67-5 | 1 |
| 4-Iodobenzoic acid | 619-58-9 | 1 |
| 3-Iodobenzoic acid | 618-51-9 | 1 |
| 4-Iodopicolinic acid | 405939-79-9 | 1 |
| 3,5-Diiodobenzoic acid | 19094-48-5 | 2 |
| 3,4-Diiodobenzoic acid | 35674-20-5 | 2 |
| 3,5-Diiodo-4-(4-methoxyphenoxy)benzoic | 34043-77-1 | 2 |
| acid | | |
| Diatrizoate | 117-96-4 | 3 |
| 2,3,5-Triiodobenzoic acid | 88-82-4 | 3 |
| Acetrizoic acid | 85-36-9 | 3 |
| Metrizoate | 1949-45-7 | 3 |
| 3,4,5-Triiodobenzoic acid | 2338-20-7 | 3 |
| Ioxitalamic acid | 28179-44-4 | 3 |
| Iothalamic acid | 2276-90-6 | 3 |
| 2,4,6-Triiodo-1,3,5-benzenetricarboxylic | 79211-41-9 | 3 |
| acid* | | |
| 2,4,6-Triiodobenzoic acid | 2012-31-9 | 3 |
| benzoic acid, 3-[[[2-hydroxy-1- | 87932-11-4 | 3 |
| (hydroxymethyl)ethyl]amino]carbonyl]-5- | | |
| [(2-hydroxy-1-oxopropyl)amino]-2,4,6- | | |
| triiodo-, (S)- (9CI) | | |
| Ioseric acid | 51876-99-4 | 3 |
| 4-[4-(Acetyloxy)-3-iodophenoxy]-3,5- | 2260-084 | 3 |
| diiodobenzoic acid | | |
| Ioglicic acid | 49755-67-1 | 3 |
| 2,4,6-Triiodo-3-[(1-oxo-3,6,9,12,15- | 16024-67-2 | 3 |
| pentaoxahexadec-1-yl)amino]benzoic acid | | |
| 3-[[(1,1-Dimethylethoxy)carbonyl]amino]- | 2358047-48-8 | 3 |
| 2,4,6-triiodobenzoic acid | | |
| 2,3,4,6-Tetraiodobenzoic acid | 71463-71-3 | 4 |
| Tetraform | 2055-97-2 | 4 |
| 2,3,5,6-Tetraiodo-1,4-benzenedicarboxylic | 7606-84-0 | 4 |
| acid* | | |
| N-Acetyl-O-(4-hydroxy-3,5-diiodophenyl)- | 26041-51-0 | 4 |
| 3,5-diiodo-L-tyrosine | | |
| D-Tyrosine, N-[(1,1- | 89624-64-6 | 4 |
| dimethylethoxy)carbonyl]-O-(4-hydroxy- | | |
| 3,5-diiodophenyl)-3,5-diiodo- (9CI, ACI) | | |
| 2,3,4,5,6-Pentaiodobenzoic acid | 64385-02-0 | 5 |
| Ioxaglic acid | 59017-64-0 | 6 |
| Ioglycamic acid* | 2618-25-9 | 6 |
| Iocarmic acid* | 10397-75-8 | 6 |

*For iodinated species that have more than 1 carboxylic acid functional group, a significant excess of the iodinated species is used during the couple reaction with gelatine to get only one to attached. The product can be further purified via chromatography methods or possible fractional crystallization.

However, as detailed herein, the iodinated amino acid NCA monomers can be formed by iodination (e.g., aromatic iodination) of various amino acids (e.g., which may or may not initially contain iodine). For instance, amino acids (e.g., amino acid NCAs) that contain one or more alcohol, amine, or carboxylic acid group may be iodinated to form iodinated amino acid NCA monomers.

Examples of suitable amino acids (e.g., amino acid NCAs which do not include an iodine atom) for forming an iodinated amino acid NCA monomers therefrom include:

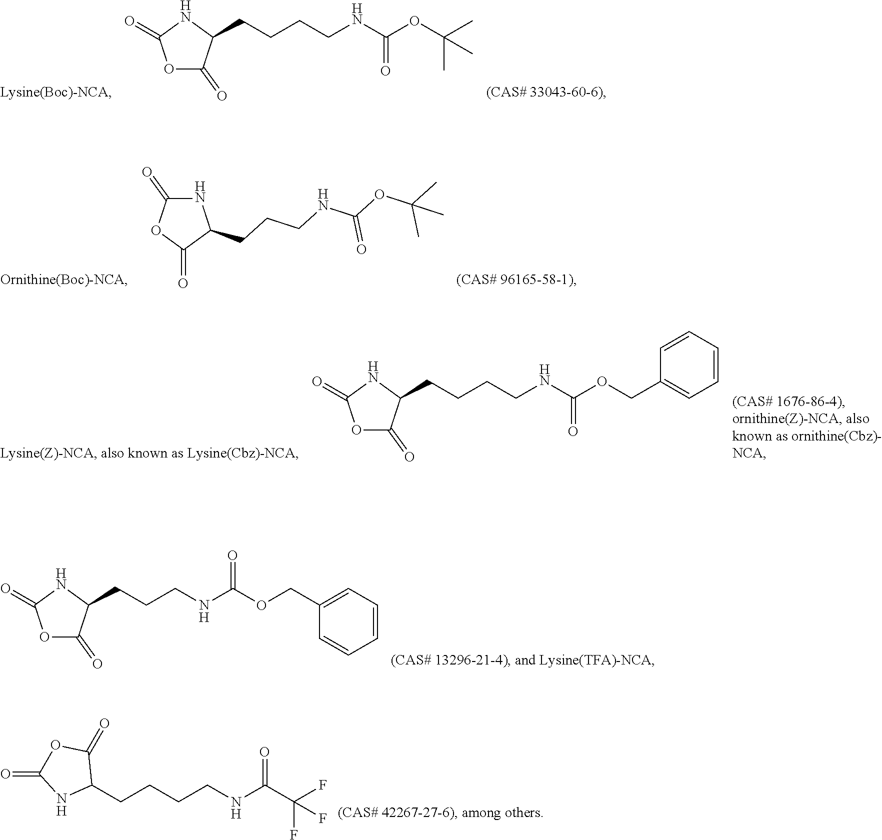 [SMILES: CC(C)(C)OC(=O)NCCCC[C@@H]1NC(=O)OC1=O ; CC(C)(C)OC(=O)NCCC[C@@H]1NC(=O)OC1=O ; O=C(NCCCC[C@@H]1NC(=O)OC1=O)OCc1ccccc1 ; O=C(NCCC[C@@H]1NC(=O)OC1=O)OCc1ccccc1 ; O=C1NC(CCCCNC(=O)C(F)(F)F)C(=O)O1]

In the present disclosure, a wide range of primary and secondary amine initiators may be employed. In some embodiments, iodinated amine initiators may be employed to provide the resulting iodinated polyamide with radiopacity. In some of these embodiments, the iodinated amine initiators are compounds that comprise a primary or secondary amine group, more typically a primary amine group, and one or more iodinated aromatic groups.

Examples of iodinated aromatic groups include iodine-substituted monocyclic aromatic groups and iodine-substituted multicyclic aromatic groups, such as iodine-substituted phenyl groups, iodine-substituted naphthyl groups, iodine-substituted anthracenyl groups, iodine-substituted phenanthrenyl groups and iodine-substituted tetracenyl groups, among others. The aromatic groups may be substituted with one, two, three, four, five, six or more iodine atoms. In some embodiments, the aromatic groups may be further substituted with one or more hydrophilic groups, for example, the aromatic groups may be further substituted with one, two, three, four, five, six or more hydrophilic groups. The one or more hydrophilic groups may comprise, for example, one or more of the following groups: hydroxyl groups, hydroxyalkyl groups (e.g., C₁-C₄-hydroxyalkyl groups containing one, two, three or four carbon atoms and containing one, two, three or four or more hydroxyl groups) and ester groups (e.g., C₂-C₆-ester groups containing two carbons, three carbons, four carbons, five carbons, six carbons, etc.) among others. The one or more hydrophilic groups may be linked to the aromatic group directly or through any suitable linking moiety, which may be selected, for example, from alkyl groups (e.g., alkyl groups containing one carbon, two carbons, three carbons, four carbons, etc.), amide groups, amine groups, ether groups, ester groups, or carbonate groups, among others.

Specific examples of iodinated initiators for use in the present disclosure include those in Tables 3 and 4.

TABLE 3
Amine containing iodinated species:

| Species | CAS | # of OH Groups |
|---|---|---|
| Iopromide | 73334-07-3 | 4 |
| 5-Acetamido-N,N′-bis(2,3-dihydroxypropyl)- | 31127-80-7 | 4 |
| 2,4,6-triiodoisophthalamide | | |
| Metrizamide | 31112-62-6 | 4 |
| 1,3-Benzenedicarboxamide, 5-(acetylamino)- | 76350-28-2 | 4 |
| N1,N3-bis(2,3-dihydroxypropyl)-2,4,6- | | |
| triiodo-N1-methyl- (ACI) | | |
| Iopamidol | 60166-93-0 | 5 |
| Iomeprol | 78649-41-9 | 5 |
| 1,3-Benzenedicarboxamide, N1,N3-bis[2- | 60208-45-9 | 5 |
| hydroxy-1-(hydroxymethyl)ethyl]-5-[(2- | | |
| hydroxy-1-oxopropyl)amino]-2,4,6-triiodo- | | |
| (ACI) | | |
| Ioxilan | 107793-72-6 | 5 |
| Iopentol | 89797-00-2 | 5 |
| Ioversol | 87771-40-2 | 6 |
| Iohexol | 66108-95-0 | 6 |
| Iobitridol | 136949-58-1 | 6 |
| Iodixanol | 92339-11-2 | 9 |
| 1,3-Benzenedicarboxamide, 5,5′-[(1,3-dioxo- | 79770-24-4 | 12 |
| 1,3-propanediyl)bis(methylimino)]bis[N,N′- | | |
| bis[2,3-dihydroxy-1-(hydroxymethyl)propyl]- | | |
| 2,4,6-triiodo- (9CI, ACI) | | |

TABLE 4
Carboxylic acid containing iodinated species:

| Name | CAS | # I atoms |
|---|---|---|
| 4-Iodobenzylamine | 39959-59-6 | 1 |
| 5-Amino-N,N′-bis(2,3-dihydroxypropyl)- | 76801-93-9 | 3 |
| 2,4,6-triiodoisophthalamide | | |
| 3,5-Diiodobenzenamine | 35122-96-4 | 2 |
| 2,4,6-Triiodobenzenamine | 24154-37-8 | 3 |

Additionally examples of iodinated initiators include methyl ester derivatives of iodinated amino acids in Table 1 and/or as detailed below.

Examples of iodinated amine initiators further include iodinated amino acid esters, for example, C₁-C₅-alkyl esters of iodinated amino acids, preferably methyl esters of iodinated amino acids. Particular examples include C₁-C₅-alkyl esters of any of the iodinated amino acids described below. After polymerization is complete, the C₁-C₅-alkyl ester may be converted into the corresponding carboxylic acid, if desired.

As used herein, an “amino acid” is an organic compound that contains an amino group (—NH₂), a carboxylic acid group (—COOH), and a side group that is specific to each amino acid. Depending on the surrounding pH, the amino group may be positively charged (—NH₃⁺) and/or the carboxylic acid group may be negatively charged (—COO⁻). An iodinated amino acid is an amino acid in which the side group contains one or more iodine atoms.

In various embodiments, the side group of the iodinated amino acid comprises one, two, three, four, five, six, seven, eight or more or more iodinated aromatic groups. The one or more iodinated aromatic groups may be directly linked to the remainder of the amino acid, linked to the remainder of the amino acid through a suitable linking moiety, which may be selected, for example, from alkyl groups (e.g., C₁-C₄-alkyl groups containing one carbon, two carbons, three carbons, four carbons, etc.), amide groups, amine groups, ether groups, ester groups, or carbonate groups, among others, or linked to another iodinated aromatic group through a suitable linking moiety, which may be selected, for example, from alkyl groups (e.g., C₁-C₄-alkyl groups containing one carbon, two carbons, three carbons, four carbons, etc.), amide groups, amine groups, ether groups, ester groups, or carbonate groups, among others. Examples of iodinated aromatic groups include iodine-substituted monocyclic aromatic groups and iodine-substituted multicyclic aromatic groups such as those set forth above.

Examples of iodinated amino acid esters include iodinated alpha-amino acid esters, iodinated beta-amino acid esters, iodinated gamma-amino acid esters, iodinated delta-amino acid esters, and iodinated epsilon-amino acid esters, among others.

Specific examples of iodinated amino acid ester initiators include the following:

monoiodo-phenylalanine methyl ester,

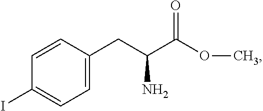 [SMILES: COC(=O)[C@@H](N)Cc1ccc(I)cc1]

monoiodotyrosine methyl ester,

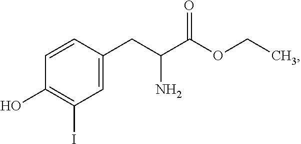 [SMILES: CCOC(=O)C(N)Cc1ccc(O)c(I)c1]

Diiodotyrosine methyl ester,

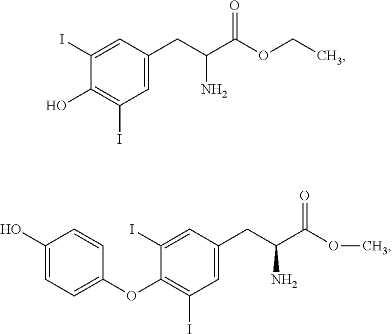 [SMILES: CCOC(=O)C(N)Cc1cc(I)c(O)c(I)c1 ; COC(=O)[C@@H](N)Cc1cc(I)c(Oc2ccc(O)cc2)c(I)c1]

triidothyronine methyl ester, also known as T3 methyl ester,

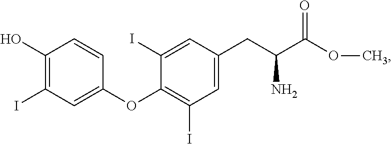 [SMILES: COC(=O)[C@@H](N)Cc1cc(I)c(Oc2ccc(O)c(I)c2)c(I)c1]

tetraidothyronine methyl ester, also known as thyroxine methyl ester or T4 methyl ester,

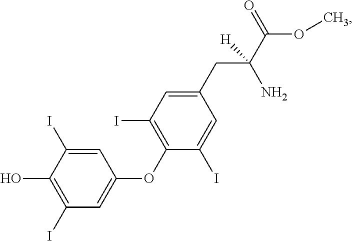 [SMILES: COC(=O)[C@@H](N)Cc1cc(I)c(Oc2cc(I)c(O)c(I)c2)c(I)c1]

thyroxine methyl ester,

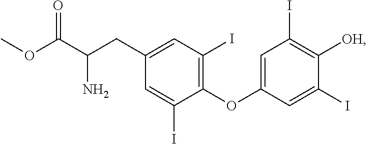 [SMILES: COC(=O)C(N)Cc1cc(I)c(Oc2cc(I)c(O)c(I)c2)c(I)c1]

and bis-thyroxine methyl ester (w/ multi-arm-linker),

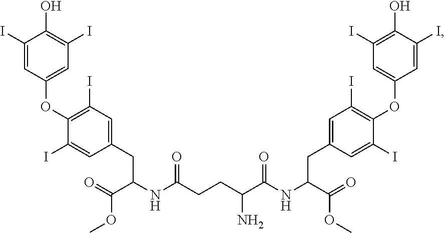 [SMILES: COC(=O)C(Cc1cc(I)c(Oc2cc(I)c(O)c(I)c2)c(I)c1)NC(=O)CCC(N)C(=O)NC(Cc1cc(I)c(Oc2cc(I)c(O)c(I)c2)c(I)c1)C(=O)OC]

and 6-iodo-L-DOPA methyl ester, among others. Altough methyl esters are shown, higher alkyl esters may be employed.

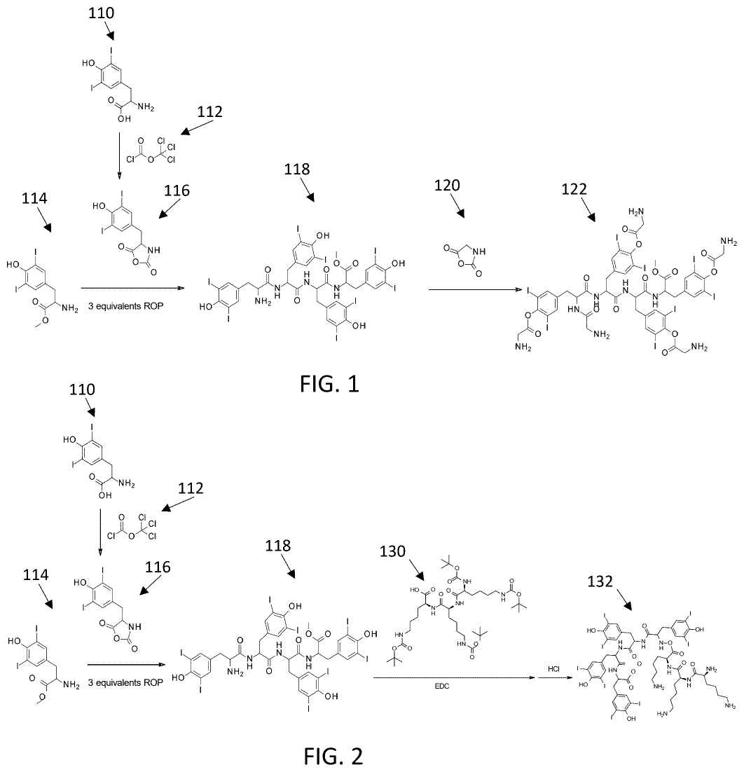

A particular example of a procedure in accordance with the present disclosure wherein an iodinated polyamide compound is formed by ring-opening polymerization of an iodinated amino acid NCA derivative will now be described with reference to FIG. 1. Similar procedures and/or alternate procedures e.g., including reaction conditions and other procedural details typically associated with forming NCA monomers and/or NCA derivatives are described in WO/2002034237A1, titled “ACTIVE AGENT DELIVERY SYSTEMS AND METHODS FOR PROTECTING AND ADMINISTERING ACTIVE AGENTS” and U.S. patent application Ser. No. 18/781,773, titled, “CROSSLINKING AGENTS AND MEDICAL HYDROGELS FORMED THEREFROM” the entire contents of both applications are herein incorporated by reference. In FIG. 1, a diiodotyrosine (DIT NCA) (116) iodinated NCA monomer is formed by reacting an iodinated amino acid in the form of diiodotyrosine (110) with phosgene or a phosgene derivative. Specifically, the diiodotyrosine (DIT NCA) (116) iodinated NCA monomer is formed by reacting the diiodotyrosine (110) with diphosgene (112), as illustrated in FIG. 1. Triphosgene or various phosgene derivatives are also suitable.

In a subsequent step, a methyl ester derivative (114) of the DIT is reacted with the DIT NCA iodinated NCA monomer (116) to form a tri-DIT derivative (118) (e.g., an intermediate iodinated compound). A methyl ester derivative (114) of DIT-to-DIT NCA (116) ratio of about 3:1 is employed in the ring-opening polymerization of FIG. 1. The methyl ester derivative (114) of DIT-to-DIT NCA (116) can be altered to reach a desired quantity of monomeric units. For instance, employing a ratio of about 3:1 yields trimers, while employing a ratio of about 2:1 yields dimers.

As illustrated in FIG. 1, the tri-DIT derivative (118) includes one amine and four hydroxyl groups. As detailed herein, some or all of the hydroxyl groups can be converted to amines. For instance, the hydroxyls groups can be converted to amines via ring opening polymerization of the tri-DIT derivative (118) with Sar-NCA (120) to form an iodinated polyamide compound (132), as illustrated in FIG. 1. Alternatively, esterification of the tri-DIT derivative (118) with a coupling agent (e.g., a carbodiimide coupling agent such as N,N′-dicyclohexylcarbodiimide (DCC)) can yield the same final molecule (e.g., iodinated polyamide compound (122).

Another particular example of a procedure in accordance with the present disclosure wherein an iodinated polyamide compound is formed will now be described with reference to FIG. 2. FIG. 2 is initially similar to FIG. 1 (e.g., with respect to the formation of DIT NCA (116) and the tri-DIT derivative (118)), but rather than adding on the amino groups of the tri-DIT derivative (118) as described with respect to FIG. 1, an iodinated polyamide (132) is formed by coupling the tri-DIT derivative (118) with a coupling agent. Examples of suitable coupling agents (e.g., amine containing moieties), are described herein. For instance, the tri-DIT derivative (118) can be reacted with a coupling agent (1-ethyl-3-(3-dimethyl propyl) carbodiimide (EDC) (130)) and can subsequently be deprotected by acidification (e.g., with HCL) to yield the iodinated polyamide compound (132), as illustrated in FIG. 2.

It is noted that the products of the ring-opening polymerization processes described herein will be statistical products meaning that the polyamide derivatives of varying length (e.g., including different length peptide chains) will be produced. Therefore, in various embodiments, the products of the ring-opening polymerization processes described herein may be subjected to a further purification step to separate the desired product (e.g., the tri-DIT derivative (118), etc.) from products of differing length (which will have a lower or higher molecular weight). Techniques for separating compounds based on their molecular weights include high-performance liquid chromatography (HPLC), simulated moving bed chromatography, ion exchange separations, and membrane filtration, among others.

The presently described synthesis procedures allow the number of primary amine crosslinking groups to be tuned without the need for additional synthetic steps, which would otherwise increase the cost of the formation of the products described herein (e.g., crosslinking agents). Additionally, the iodinated polyamide products of the present disclosure contain one or more ester linkages, thus providing a mechanism (the alkyl ester products formed herein can be converted to carboxylic acid products) for hydrolysis to make the resultant hydrogel formed from the iodinated polyamide products biodegradable. Moreover, it is noted that the iodinated initiator and the iodinated NCA monomers herein can be from the same chemical family or can be from different chemical families, thereby affording an added degree of flexibility and/or cost savings, etc. when selecting components to form the products herein.

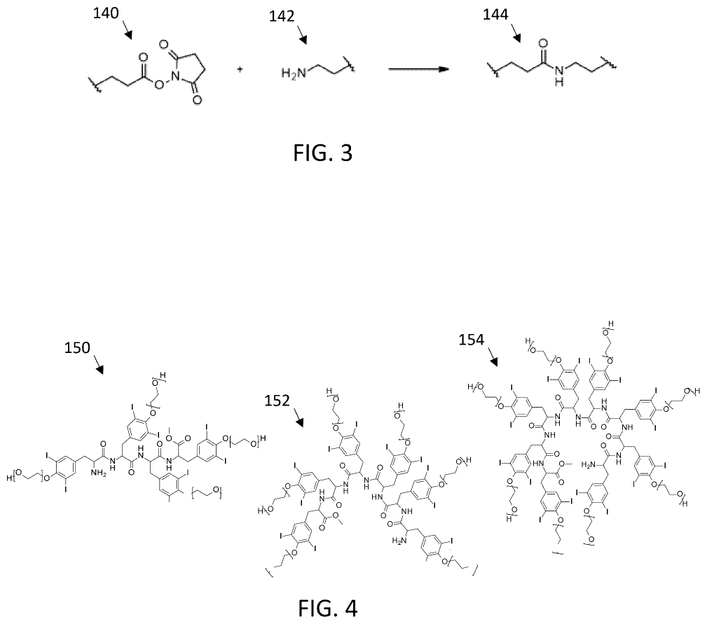

The iodinated polyamide products of the present disclosure have utility at least as crosslinking agents due to the presence of primary amine groups. For instance, the nucleophilic primary amine groups of the iodinated polyamide products of the present disclosure can react with a multi-arm polymer containing electrophilic groups, such as succinimidyl glutarates (SG). For example, with reference to FIG. 3, a succinimidyl-ester-terminated multi-arm PEG (140) (only one arm is illustrated) rapidly reacts with a nucleophilic amine group (142) (only one amine group is illustrated) of the iodinated polyamide product to yield a crosslinked hydrogel product (144) with crosslinks (only one crosslink is illustrated). Although a succinimidyl glutarates-terminated multi-arm PEG is employed in FIG. 3, it will be appreciated that other multi-arm polymers (e.g., including hydroxyl and/or TIB termination groups) may be used including those containing the polymer chains as described above.

Further, the iodinated polyamide products of the present disclosure can be utilized as core initiators to form radiopaque star polymers e.g., multi-arm hydrophilic polymers (PEG, Oxazoline, polyesters, etc.). For example, the alcohol groups of the iodinated polyamide products of can be ethoxylated to form multi-arm radiopaque PEG polymers, as detailed herein. A quantity of arms on the multi-arm radiopaque (e.g., PEG) polymers can be tuned by varying the ring-opening polymerization conditions and/or molar equivalencies of the NCA monomers. For instance, the ring-opening polymerization conditions and/or molar equivalencies of the NCA monomers can be varied to yield multi-arm radiopaque PEG polymers such as a four-arm radiopaque PEG polymers (e.g., the four-arm PEG polymer 150, as illustrated in FIG. 4), a six-arm radiopaque PEG polymers (e.g., the six-arm PEG polymer 152, as illustrated in FIG. 4), or an eight-arm radiopaque PEG polymers (e.g., the eight-arm PEG polymer 154, as illustrated in FIG. 4), etc.

The resultant hydrogels formed from the components herein (e.g. formed from an iodinated polyamide compound or a multi-arm radiopaque (e.g., PEG) polymers) can exhibit improved radiopacity, for instance, due to being formed from iodinated amino acids (e.g., amino acids which are initially iodinated or amino acids which are iodinated, as detailed herein) and iodinated NCA monomers. For example, a quantity of iodine in the multi-arm radiopaque PEG polymers herein can be relative higher than a quantity of iodine in other multi-arm PEG polymers. For instance, each or of the multi-arm radiopaque PEG polymers herein can include at least one iodine or at least two iodine substituents. Stated differently, the For example, each of the multi-arm radiopaque PEG polymers 150/152/154 in FIG. 4 include at least two iodine substituents per arm (e.g., at least two iodine ring substituent groups per arm). Thus, in some embodiments an iodine to arm ratio for the multi-arm radiopaque PEG polymers can be 2:1 or greater. For instance, the multi-arm radiopaque PEG polymers herein can include a total of at least four iodine substituents, at least six iodine substituents, at least eight iodine substituents, at least ten iodine substituents, at least twelve iodine substituents, at least fourteen iodine substituents, at least sixteen iodine substituents, etc. At least due to the multi-arm radiopaque PEG polymers herein having a higher total quantity of iodine and/or a higher iodine per arm ratio, hydrogels from with the multi-arm radiopaque PEG polymers herein can exhibit improved radiopacity (e.g., when employed in a hydrogel in the same relative amounts in a hydrogel as another multi-arm radiopaque PEG polymers with less iodine).

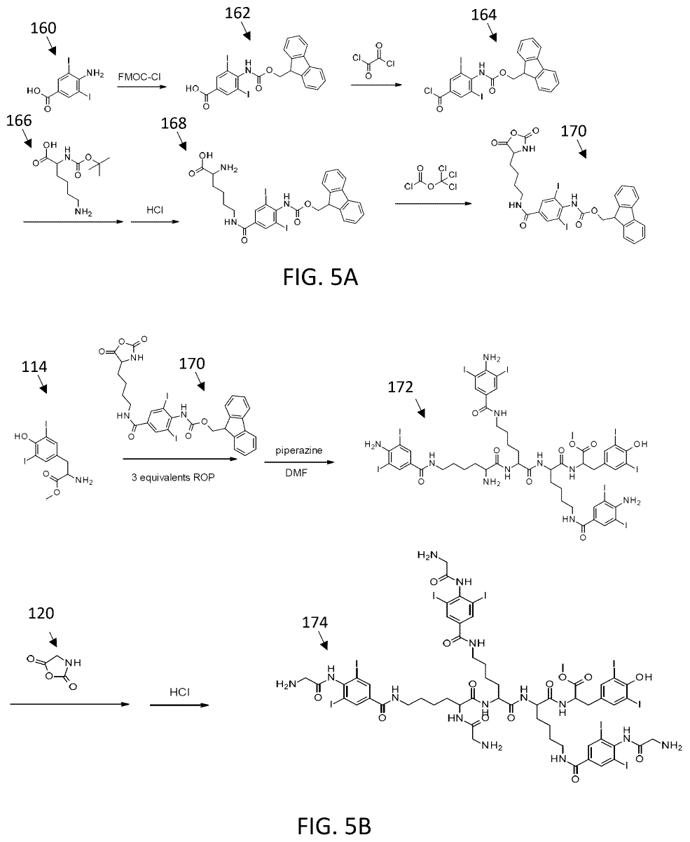

FIG. 5A illustrates another example of a procedure in accordance with the present disclosure for formation of an iodinated NCA monomer that is suitable for formation of iodinated polyamide products herein. As illustrated in FIG. 5A, an iodinated NCA monomer is formed from an amino acid that is not initially iodinated. Specifically, FMOC-protected 4-amino-3,5 diiodobenzoic acid (164) is formed by protecting 3,5-diiodosalicylic acid (160) with a fluorenylmethyloxycarbonyl protecting group (FMOC-CL) followed by reaction with oxalyl chloride to yield FMOC-protected 4-amino-3,5 diiodobenzoic acid (164). Subsequently, Boc-lysine (166) (e.g., an amino acid that is not initially iodinated) is reacted with the FMOC-protected 4-amino-3,5 diiodobenzoic acid (164) to yield a derivative compound (168) that undergoes acid treatment and reaction with diphosgene to yield the iodinated NCA monomer (170). That is, the iodinated polyamide products of the present disclosure can be formed from iodinated amino acids or from amino acids that are not initially iodinated, as detailed herein.

For instance, FIG. 5B illustrates the formation of an iodinated polyamide product from the iodinated NCA monomer (170) of FIG. 5A. As illustrated in FIG. 5B, the iodinated NCA monomer (170) can be undergo ring-opening polymerization in the presence of an iodinated initiator in the form of a methyl ester derivative (114) of the DIT followed by FMOC removal (with piperazine and DMF) to form a DIT derivative (172). An iodinated NCA monomer (170) to methyl ester derivative (114) of DIT ratio of about 3:1 is employed in ring-opening polymerization of FIG. 5B. However, as mentioned the ratio of the iodinated NCA monomer to iodinated initiator can be altered to reach a desired quantity of monomeric units. For instance, employing a ratio of about 3:1 yields trimers, while employing a ratio of about 2:1 yields dimers.

In some instances, the DIT derivative (172) can undergo further reaction (e.g., ring-opening or esterification). For instance, the primary amines on the DIT derivative (172) may or may not be quick to form a hydrogel. Further reaction of the DIT derivative (172) can expediate hydrogel formation. For example, an amine linker can be added to the DIT derivative (172), thereby converting some or all of the hydroxyl groups of the DIT derivative (172) to amines. For instance, the hydroxyls groups can be converted to amines via ring opening polymerization of the DIT derivative (172) with Sar-NCA (120) followed by acidification (e.g., with HCL) to form an iodinated polyamide compound (174), as illustrated in FIG. 4B. Alternatively, esterification of the DIT derivative (172) with a coupling agent (e.g., a carbodiimide coupling agent such as N,N′-dicyclohexylcarbodiimide (DCC)) can yield the same final molecule (e.g., iodinated polyamide compound (174).

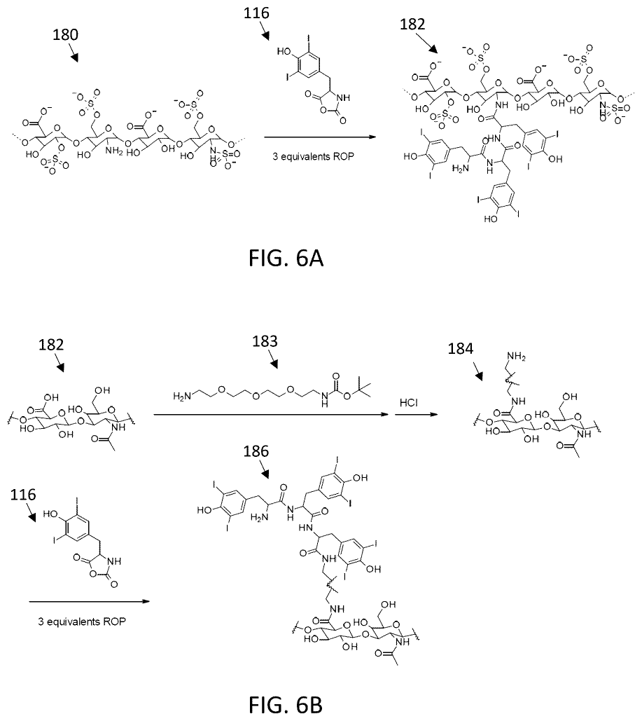

In some aspects, the present disclosure provides methods of directly iodinating a crosslinked hydrogel (e.g., with or without functionalizing the cross-linked hydrogel). FIG. 6A illustrates another example of a procedure in accordance with the present disclosure wherein a hydrogel is directly iodinated with an iodinated NCA monomer. That is, a hydrogel that is already formed can be iodinated (or further iodinated) via reaction with an iodinated NCA monomer. The hydrogel can be formed via various mechanisms including those described herein. As mentioned, the iodinated NCA monomer can be an iodinated NCA monomer that is initially iodinated or that is not initially iodinated and is iodinated, as described herein. As illustrated in FIG. 6A, a hydrogel 180 includes a plurality of nucleophilic groups, such as amines, that can initiate or be involved in ring-opening polymerization. For instance, if the hydrogel contains nucleophilic groups such as the primary amines of heparin, the direct ring-opening polymerization of the iodinated NCA monomer will yield iodination (or further iodination) or the hydrogel. For example, as illustrated in FIG. 6A the iodinated amino acid NCA in the form of DIT NCA (116) can undergo ring-opening polymerization in the presence of the hydrogel (180) to yield a directly iodinated cross-linked hydrogel (182). A DIT NCA (116) to hydrogel ratio of about 3:1 is employed in the ring-opening polymerization of FIG. 6A. Thus, in some embodiments, a method of iodinating a crosslinked hydrogel comprises forming a crosslinked hydrogel having a plurality of nucleophilic groups. Subsequently, the method comprises performing ring-opening polymerization of one or more types of iodinated amino acid NCA monomers having at least one iodinated group and at least one aromatic amine substitute in the presence of the cross-linked hydrogel to form an iodinated crosslinked hydrogel having iodine groups and pendant amine groups covalently attached to the residue of the iodinated amino acid NCA monomer.

In instances where the hydrogel (182) does not initially contain an amine, such as is the case with hyaluronic acid, the hydrogel (182) can be functionalized with an amine containing compound such as with a primary amine compound. For example, the hyaluronic acid within the hydrogel (182) can be reacted with a mono protected diamine, such as 1,1 dimethylethyl 13-amino-5,8,11-trioxa-2-azatridecanoate (183) (CAS 101187-40-0) to form an amine functionalized hydrogel derivative (184) thereof. Subsequently, an iodinated amino acid NCA in the form of DIT NCA (116) can undergo ring-opening polymerization in the presence of the amine functionalized hydrogel derivative (184) to yield a directly iodinated hydrogel (182). A DIT NCA (116) to hydrogel derivative (184) ratio of about 3:1 is employed in the ring-opening polymerization of FIG. 6B. Thus, in some embodiments, a method of directly iodinating a hydrogel comprises functionalizing a cross-linked hydrogel with an amine group and subsequently performing the ring-opening polymerization of one or more types of iodinated amino acid NCA monomers having at least one iodinated group and at least one aromatic amine substitute in the presence of the cross-linked hydrogel to form an iodinated crosslinked hydrogel having iodine groups and pendant amine groups covalently attached to the residue of the iodinated amino acid NCA monomer.

In other embodiments of the present disclosure, amino acid NCA polymerization is initiated by a hydroxyl-group-containing initiator. This polymerization is performed by acid catalyzed initiation, followed by base quenching and polymerization, with the acid catalyst being methane sulfonic acid. Base quenching can be accomplished with N-ethyldiisopropylamine, or triethylamine.

In the present disclosure, a wide range of hydroxyl-group-containing iodinated initiators may be employed. In some embodiments, hydroxyl-group-containing iodinated initiators may be employed to provide the resulting polyamide with radiopacity. In some of these embodiments, the hydroxyl-group-containing iodinated initiators are compounds that comprise a hydroxyl group and one or more iodinated aromatic groups. Examples of iodinated aromatic groups include iodine-substituted monocyclic aromatic groups and iodine-substituted multicyclic aromatic groups such as those set forth above. In some embodiments, the one or more hydroxyl groups are found in hydroxyl-group-containing ring substituents of the iodine-substituted monocyclic aromatic groups or the iodine-substituted multicyclic aromatic groups. For example, the iodine-substituted monocyclic aromatic groups and/or the iodine-substituted multicyclic aromatic groups may be substituted with one or more C₁-C₆-hydroxyalkyl groups. Where two or more hydroxyl groups are present on the iodinated initiator, a branched peptide may be formed.

It is also noted that although iodine groups are specifically described herein, other radiopaque halogen groups including bromine may be employed.

It is further noted that, although the above-described initiators are iodinated initiators, non-iodinated initiators are useful in the present disclosure as well. Particular examples of non-iodinated initiators include ammonium chloride, hexamethyldisilazane (CAS 999-97-3), which, upon deprotection by a fluoride source, would yield trilysine, and other aliphatic amines, or trimethylsilyl protected aliphatic amines. Additionally, transition metal initiators can be used to polymerize the NCA monomers. These transition metal complexes can include Cobalt, Nickel, etc., and can be removed via precipitation or dialysis after polymerization

In other embodiments, radiopacity can be introduced into the final product by using iodinated amino acid NCA derivatives in the ring-opening synthesis. For example, protected iodinated phenylalanine NCA or protected iodinated tyrosine NCA may be used in the ring-opening synthesis in some embodiments. These could be used to form statistical copolymers, gradient copolymers, or block copolymers with the protected amine containing NCA derivatives.

In some embodiments, the crosslinked hydrogel is visible under fluoroscopy. The crosslinked hydrogel may have a radiopacity that is greater than 100 Hounsfield units (HU), beneficially anywhere ranging from 100 HU to 250 HU to 500 HU to 750 HU to 1000 HU to 2000 HU or more (in other words, ranging between any two of the preceding numerical values).

Reactive polymers for use in the present disclosure include reactive multi-arm polymers that comprise a plurality of polymer arms linked to a core region, at least a portion of the arms comprising a hydrophilic polymer segment. One end of the hydrophilic polymer segment is covalently linked to the core region and an opposite end of the hydrophilic polymer segment is covalently linked to a reactive moiety.

In certain embodiments, at least a portion of the polymer arms comprise a hydrophilic polymer segment that has first and second ends, the first end of the hydrophilic polymer segment covalently linked to the core region, a cyclic anhydride residue having first and second ends, the first end of the cyclic anhydride residue covalently linked to the second end of the hydrophilic polymer segment, and a reactive moiety that is covalently linked to the second end of the cyclic anhydride residue.

Reactive polymers in accordance with the present disclosure include polymers having from 3 to 100 arms, for example ranging anywhere from 3 to 4 to 5 to 6 to 7 to 8 to 10 to 12 to 15 to 20 to 25 to 50 to 75 to 100 arms (in other words, having a number of arms ranging between any two of the preceding values).

Reactive moieties include moieties that comprise electrophilic groups.

Electrophilic groups may be selected, for example, from cyclic imide ester groups, such as succinimide ester groups,

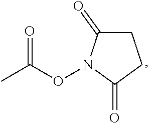

maleimide ester groups, glutarimide ester groups, diglycolimide ester groups, phthalimide ester groups, and bicyclo[2.2.1]hept-5-ene-2,3-dicarboxylic acid imide ester groups,

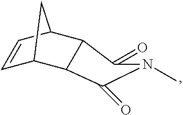

imidazole ester groups, imidazole carboxylate groups and benzotriazole ester groups, among other possibilities.

The electrophilic groups may be linked to the hydrophilic polymer segment through any suitable linking moiety, which may be selected, for example, from a linking moiety that comprises an alkyl group, a linking moiety that comprises an ether group, a linking moiety that comprises an ester group, a linking moiety that comprises an amide group, a linking moiety that comprises an amine group, a linking moiety that comprises a carbonate group, or a linking moiety that comprises a combination of two or more of the foregoing groups, among others. In certain embodiments, the linking moiety comprises a hydrolysable ester group.

Hydrophilic polymer segments for the polymer arms can be selected from a variety of synthetic, natural, or hybrid synthetic-natural hydrophilic polymer segments. Examples of hydrophilic polymer segments include those that are formed from one or more hydrophilic monomers selected from the following: C₁-C₆-alkylene oxides (e.g., ethylene oxide, propylene oxide, tetramethylene oxide, etc.), polar aprotic vinyl monomers (e.g. N-vinyl pyrrolidone, acrylamide, N-methyl acrylamide, dimethyl acrylamide, N-vinylimidazole, 4-vinylimidazole, sodium 4-vinylbenzenesulfonate, etc.), dioxanone, ester monomers (e.g. glycolide, lactide, β-propiolactone, β-butyrolactone, γ-butyrolactone, γ-valerolactone, δ-valerolactone, ε-caprolactone, etc.), oxazoline monomers (e.g., oxazoline and 2-alkyl-2-oxazolines, for instance, 2-(C₁-C₆ alkyl)-2-oxazolines, including various isomers, such as 2-methyl-2-oxazoline, 2-ethyl-2-oxazoline, 2-n-propyl-2-oxazoline, 2-isopropyl-2-oxazoline, 2-n-butyl-2-oxazoline, 2-isobutyl-2-oxazoline, 2-hexyl-2-oxazoline, etc.), 2-phenyl-2-oxazoline, N-isopropylacrylamide, amino acids, peptoids (e.g. N-substituted glycines, including N-methyl glycine or sarcosine), and sugars.

Hydrophilic polymer segments may be selected, for example, from the following polymer segments: polyether segments including poly(C₁-C₆-alkylene oxide) segments such as poly(ethylene oxide) (PEO) (also referred to as polyethylene glycol or PEG) segments, poly(propylene oxide) segments, poly(ethylene oxide-co-propylene oxide) segments, polymer segments formed from one or more polar aprotic vinyl monomers, including poly(N-vinyl pyrrolidone) segments, poly(acrylamide) segments, poly(N-methyl acrylamide) segments, poly(dimethyl acrylamide) segments, poly(N-vinylimidazole) segments, poly(4-vinylimidazole) segments, and poly(sodium 4-vinylbenzenesulfonate) segments, polydioxanone segments, polyester segments including polyglycolide segments, polylactide segments, poly(lactide-co-glycolide) segments, poly(β-propiolactone) segments, poly(β-butyrolactone) segments, poly(γ-butyrolactone) segments, poly(γ-valerolactone) segments, poly(δ-valerolactone) segments, and poly(ε-caprolactone) segments, polyoxazoline segments including poly(2-C₁-C₆-alkyl-2-oxazoline segments) such as poly(2-methyl-2-oxazoline) segments, poly(2-ethyl-2-oxazoline) segments, poly(2-propyl-2-oxazoline) segments, poly(2-isopropyl-2-oxazoline) segments, and poly(2-n-butyl-2-oxazoline) segments, poly(2-phenyl-2-oxazoline) segments, poly(N-isopropylacrylamide) segments, polypeptoid segments (e.g., poly(N-substituted glycines), including polysarcosine), polypeptide segments, and polysaccharide segments. Polysaccharide segments include those that contain one or more uronic acid species, such as galacturonic acid, glucuronic acid and/or iduronic acid, with particular examples of polysaccharide segments including alginic acid, hyaluronic acid, pectin, agaropectin, carrageenan, gellan gum, gum arabic, guar gum, xanthan gum, and carboxymethyl cellulose moieties.

Polymer segments for use in the multi-arm polymers of the present disclosure typically contain between 10 and 1000 monomer units or more.

In certain embodiments, the core region comprises a residue of a polyol comprising three or more hydroxyl groups, which is used to form the polymer arms. In certain beneficial embodiments, the core region comprises a residue of a polyol that contains from 3 to 100 hydroxyl groups.

Illustrative polyols may be selected, for example, from straight-chained, branched and cyclic aliphatic polyols including straight-chained, branched and cyclic polyhydroxyalkanes, straight-chained, branched and cyclic polyhydroxy ethers, including polyhydroxy polyethers, straight-chained, branched and cyclic polyhydroxyalkyl ethers, including polyhydroxyalkyl polyethers, straight-chained, branched and cyclic sugars and sugar alcohols, such as glycerol, mannitol, sorbitol, inositol, xylitol, quebrachitol, threitol, arabitol, erythritol, pentaerythritol, dipentaerythritol, tripentaerythritol, adonitol, hexaglycerol, dulcitol, fucose, ribose, arabinose, xylose, lyxose, rhamnose, galactose, glucose, fructose, sorbose, mannose, pyranose, altrose, talose, tagatose, pyranosides, sucrose, lactose, and maltose, polymers (defined herein as two or more units) of straight-chained, branched and cyclic sugars and sugar alcohols, including oligomers (defined herein as ranging from two to ten units, including dimers, trimers, tetramers, pentamers, hexamers, heptamers, octamers, enneamers and decamers) of straight-chained, branched and cyclic sugars and sugar alcohols, including the preceding sugars and sugar alcohols, starches, amylose, dextrins, cyclodextrins, as well as polyhydroxy crown ethers, and polyhydroxyalkyl crown ethers. Illustrative polyols also include aromatic polyols including 1,1,1-tris(4′-hydroxyphenyl) alkanes, such as 1,1,1-tris(4-hydroxyphenyl) ethane, and 2,6-bis(hydroxyalkyl) cresols, among others.

Illustrative polyols also include polyhydroxylated polymers. For example, in some embodiments, the core region comprises a polyhydroxylated polymer residue such as a poly(vinyl alcohol) residue, poly(allyl alcohol), polyhydroxyethyl acrylate residue, or a polyhydroxyethyl methacrylate residue, among others. Such polyhydroxylated polymer residues may range, for example, from 3 to 100 monomer units in length.

In other embodiments, the core region comprises a silsesquioxane, which is a compound that has a cage-like silicon-oxygen core that is made up of Si—O—Si linkages and tetrahedral Si vertices. —H groups or exterior organic groups may be covalently attached to the cage-like silicon-oxygen core. In the present disclosure, the organic groups comprise polymer arms. Silsesquioxanes for use in the present disclosure include silsesquioxanes with 6 Si vertices, silsesquioxanes with 8 Si vertices, silsesquioxanes with 10 Si vertices, and silsesquioxanes with 12 Si vertices, which can act, respectively, as cores for 6-arm, 8-arm, 10-arm and 12-arm polymers. The silicon-oxygen cores are sometimes referred to as T6, T8, T10, and T12 cage-like silicon-oxygen cores, respectively (where T=the number of tetrahedral Si vertices). In all cases each Si atom is bonded to three O atoms, which in turn connect to other Si atoms. Silsesquioxanes include compounds of the chemical formula [RSiO_{3/2}]ₙ, where n is an integer of at least 6, commonly 6, 8, 10 or 12 (thereby having T₆, T₈, T₁₀ or T₁₂ cage-like silicon-oxygen core, respectively), and where R may be selected from an array of organic functional groups such as alkyl groups, aryl groups, alkoxyl groups, and polymeric arms, among others. The T₈ cage-like silicon-oxygen cores are widely studied and have the formula [RSiO_{3/2}]₈, or equivalently R₈Si₈O₁₂. Such a structure is shown here:

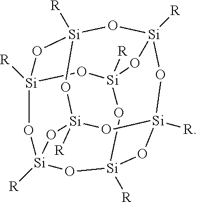

In the present disclosure, the R groups comprise the polymer arms described herein.

Reactive multi-arm polymers in accordance with the present disclosure can be formed from hydroxy-terminated precursor multi-arm polymers having arms that comprise one or more hydroxyl end groups. In some of these embodiments, the hydroxy-terminated precursor multi-arm hydrophilic polymer may be reacted with a cyclic anhydride to form an acid-end-capped precursor polymer. For example, terminal hydroxyl groups of the hydrophilic segments may be reacted with a cyclic anhydride (e.g., a glutaric anhydride compound, a succinic anhydride compound, a malonic anhydride compound, an adipic anhydride compound, a diglycolic anhydride compound, etc.) to form an acid-end-capped segment such as a glutaric-acid-end-capped segment, a succinic-acid-end-capped segment, a malonic-acid-end-capped segment, an adipic-acid-end-capped segment, a diglycolic-acid-end-capped segment, and so forth.

The preceding cyclic anhydrides, among others, may be reacted with a hydroxy-terminated precursor multi-arm hydrophilic polymer under basic conditions to form a carboxylic-acid-terminated precursor polymer comprising a carboxylic acid end group that is linked to a hydrophilic polymer segment through a hydrolysable ester group.

A reactive moiety may then be linked to the carboxylic-acid-terminated precursor polymer.

In some embodiments, an electrophilic moiety may be linked to the carboxylic-acid-terminated precursor polymer. For instance, an N-hydroxy cyclic imide compound (e.g., N-hydroxysuccinimide, N-hydroxymaleimide, N-hydroxyglutarimide, N-hydroxyphthalimide, or N-hydroxy-5-norbornene-2,3-dicarboxylic acid imide, also known as N-hydroxybicyclo[2.2.1]hept-5-ene-2,3-dicarboxylic acid imide (HONB), etc.) may be reacted with the carboxylic-acid-terminated precursor polymer in the presence of a suitable coupling agent (e.g., a carbodiimide coupling agent such as N,N′-dicyclohexylcarbodiimide (DCC), 1-ethyl-3-(3-dimethyl propyl) carbodiimide (EDC), N-hydroxybenzotriazole (HOBt), BOP reagent, and/or another coupling agent) to form a reactive cyclic imide ester (e.g., a succinimide ester group, a maleimide ester group, a glutarimide ester group, a phthalimide ester group, a diglycolimide ester group, a bicyclo[2.2.1]hept-5-ene-2,3-dicarboxylic acid imide ester group, etc.) that is linked to a hydrophilic polymer segment through a hydrolysable ester group. In this way, a number of reactive diester groups can be formed.

For example, in the particular case of N-hydroxysuccinimide as an N-hydroxy cyclic imide compound, exemplary reactive end groups include succinimidyl malonate groups, succinimidyl glutarate groups, succinimidyl succinate groups, succinimidyl adipate groups, and succinimidyl diglycolate groups, among others. In the particular case of HONB as an N-hydroxy cyclic imide compound, exemplary reactive end groups include bicyclo[2.2.1]hept-5-ene-2,3-dicarboxylic acid imidyl malonate groups, bicyclo[2.2.1]hept-5-ene-2,3-dicarboxylic acid imidyl glutarate groups, bicyclo[2.2.1]hept-5-ene-2,3-dicarboxylic acid imidyl succinate groups, bicyclo[2.2.1]hept-5-ene-2,3-dicarboxylic acid imidyl adipate groups, and bicyclo[2.2.1]hept-5-ene-2,3-dicarboxylic acid imidyl diglycolate groups, among others. In the particular case of N-hydroxymaleimide as an N-hydroxy cyclic imide compound, exemplary reactive end groups include maleimidyl malonate groups, maleimidyl glutarate groups, maleimidyl succinate groups, maleimidyl adipate groups, and maleimidyl diglycolate groups, among others. In the particular case of N-hydroxyglutarimide as an N-hydroxy cyclic imide compound, exemplary reactive end groups include glutarimidyl malonate groups, glutarimidyl glutarate groups, glutarimidyl succinate groups, glutarimidyl adipate groups, glutarimidyl diglycolate groups, among others. In the particular case of N-hydroxyphthalimide as an N-hydroxy cyclic imide compound, exemplary reactive end groups include phthalimidyl malonate groups, phthalimidyl glutarate groups, phthalimidyl succinate groups, phthalimidyl adipate groups, and phthalimidyl diglycolate groups, among others.

In some aspects of the present disclosure, a system is provided that comprises (a) a first composition that comprises an iodinated polyamide compound as described herein and (b) a second composition that comprises a reactive polymer comprising reactive moieties as described herein, wherein the system is configured to deliver the reactive polymer and the iodinated polyamide compound under conditions such that covalent crosslinks are formed between the reactive polymer and the iodinated polyamide compound (e.g., a peptide containing compound).

The first composition may be a first fluid composition comprising the iodinated polyamide compound or a first dry composition that comprises the iodinated polyamide compound, to which a suitable fluid such as water for injection, saline, etc. can be added to form a first fluid composition. In addition to the iodinated polyamide compound, the first composition may further comprise additional agents, including therapeutic agents, imaging agents, colorants, tonicity adjusting agents, suspension agents, wetting agents, and pH adjusting agents as described below.

The second composition may be a second fluid composition comprising the reactive polymer or a second dry composition that comprises the reactive polymer, to which a suitable fluid such as water for injection, saline, etc. can be added to form a second fluid composition. In addition to the reactive polymer, the second composition may further comprise additional agents, including therapeutic agents, imaging agents, colorants, tonicity adjusting agents, suspension agents, wetting agents, and pH adjusting agents as described below.

In some embodiments, the system is configured to combine a first fluid composition comprising the iodinated polyamide compound with a second fluid comprising the reactive polymer. Upon mixing the first and second fluid compositions, the iodinated polyamide compound crosslinks with the reactive polymer, forming a crosslinked product. The first and second fluid compositions may be combined form crosslinked hydrogels, either in vivo or ex vivo.

In some embodiments, the iodinated polyamide compound is initially combined with the reactive polymer under conditions where crosslinking between the reactive polymer and the iodinated polyamide compound is suppressed (e.g., an acidic pH, in some embodiments). Then, when crosslinking is desired, the conditions are changed such that crosslinking is increased (e.g., a change from an acidic pH to a basic pH, in some embodiments), leading to crosslinking between the iodinated polyamide compound and the reactive polymer, thereby forming a crosslinked product.

In some embodiments, the system comprises (a) a first composition that comprises an iodinated polyamide compound as described hereinabove, (b) a second composition that comprises a reactive polymer as described hereinabove, and (c) a third composition, specifically, an accelerant composition, that contains an accelerant that is configured to accelerate a crosslinking reaction between the iodinated polyamide compound and the reactive polymer.

The first composition may be a first fluid composition comprising the iodinated polyamide compound that is buffered to an acidic pH or a first dry composition that comprises the iodinated polyamide compound, to which a suitable fluid such as water for injection, saline, an acidic buffer solution, etc. can be added to form a first fluid composition comprising the iodinated polyamide compound that is buffered to an acidic pH. In some embodiments, for example, the acidic buffering composition may comprise monobasic sodium phosphate, among other possibilities. The first fluid composition comprising the iodinated polyamide compound may have a pH ranging, for example, from about 3 to about 5. In addition to the iodinated polyamide compound, the first composition may further comprise additional agents, including therapeutic agents, imaging agents, colorants, tonicity adjusting agents, suspension agents, wetting agents, and pH adjusting agents as described below.

The second composition may be a second fluid composition comprising the reactive polymer or a second dry composition that comprises the reactive polymer from which a fluid composition is formed, for example, by the addition of a suitable fluid such as water for injection, saline, or the first fluid composition comprising the iodinated polyamide compound that is buffered to an acidic pH. In addition to the reactive polymer, the second composition may further comprise additional agents, including therapeutic agents, imaging agents, colorants, tonicity adjusting agents, suspension agents, wetting agents, and pH adjusting agents as described below.

In a particular embodiment, the first composition is a first fluid composition comprising the iodinated polyamide compound that is buffered to an acidic pH and the second composition comprises a dry composition that comprises the reactive polymer. The first composition may then be mixed with the second composition to provide a prepared fluid composition that is buffered to an acidic pH and comprises the iodinated polyamide compound and the reactive polymer. In a particular example, a syringe may be provided that contains the first fluid composition comprising the iodinated polyamide compound that is buffered to an acidic pH, and a vial may be provided that comprises the dry composition (e.g., a powder) that comprises the reactive polymer. The syringe may then be used to inject the first fluid composition into the vial containing the reactive polymer to form a prepared fluid composition that is buffered to an acidic pH and contains the iodinated polyamide compound and the reactive polymer, which can be withdrawn back into the syringe for administration.

The accelerant composition may be a fluid accelerant composition that is buffered to a basic pH or a dry composition that comprise a basic buffering composition to which a suitable fluid such as water for injection, saline, etc. can be added to form a fluid accelerant composition that is buffered to a basic pH. For example, the basic buffering composition may comprise sodium borate and dibasic sodium phosphate, among other possibilities. The fluid accelerant composition may have, for example, a pH ranging from about 9 to about 11. In addition to the above, the fluid accelerant composition may further comprise additional agents, including those described below.

A prepared fluid composition that is buffered to an acidic pH and comprises the iodinated polyamide compound and the reactive polymer as described above, and a fluid accelerant composition that is buffered to basic pH as described above, may be combined form crosslinked hydrogels, either in vivo or ex vivo.

Additional agents for use in the compositions described herein include therapeutic agents, imaging agents, colorants, tonicity adjusting agents, suspension agents, wetting agents, and pH adjusting agents.

Examples of therapeutic agents include antithrombotic agents, anticoagulant agents, antiplatelet agents, thrombolytic agents, antiproliferative agents, anti-inflammatory agents, hyperplasia inhibiting agents, anti-restenosis agent, smooth muscle cell inhibitors, antibiotics, antimicrobials, analgesics, anesthetics, growth factors, growth factor inhibitors, cell adhesion inhibitors, cell adhesion promoters, anti-angiogenic agents, cytotoxic agents, chemotherapeutic agents, checkpoint inhibitors, immune modulatory cytokines, T-cell agonists, STING (stimulator of interferon genes) agonists, antimetabolites, alkylating agents, microtubule inhibitors, hormones, hormone antagonists, monoclonal antibodies, antimitotics, immunosuppressive agents, tyrosine and serine/threonine kinases, proteasome inhibitors, matrix metalloproteinase inhibitors, Bcl-2 inhibitors, DNA alkylating agents, spindle poisons, poly(DP-ribose) polymerase (PARP) inhibitors, and combinations thereof.

Examples of imaging agents include (a) fluorescent dyes such as fluorescein, indocyanine green, or fluorescent proteins (e.g. green, blue, cyan fluorescent proteins), (b) contrast agents for use in conjunction with magnetic resonance imaging (MRI), including contrast agents that contain elements that form paramagnetic ions, such as Gd(III), Mn(II), Fe(III) and compounds (including chelates) containing the same, such as gadolinium ion chelated with diethylenetriaminepentaacetic acid, (c) contrast agents for use in conjunction with ultrasound imaging, including organic and inorganic echogenic particles (i.e., particles that result in an increase in the reflected ultrasonic energy) or organic and inorganic echolucent particles (i.e., particles that result in a decrease in the reflected ultrasonic energy), (d) contrast agents for use in connection with near-infrared (NIR) imaging, which can be selected to impart near-infrared fluorescence to the hydrogels of the present disclosure, allowing for deep tissue imaging and device marking, for instance, NIR-sensitive nanoparticles such as gold nanoshells, carbon nanotubes (e.g., nanotubes derivatized with hydroxy or carboxyl groups, for instance, partially oxidized carbon nanotubes), dye-containing nanoparticles, such as dye-doped nanofibers and dye-encapsulating nanoparticles, and semiconductor quantum dots, among others, and NIR-sensitive dyes such as cyanine dyes, squaraines, phthalocyanines, porphyrin derivatives and boron dipyrromethene (BODIPY) analogs, among others, (e) imageable radioisotopes including 99mTc, 201Th, 51Cr, 67Ga, 68Ga, 111 In, 64Cu, 89Zr, 59Fe, 42K, 82Rb, 24Na, 45Ti, 44Sc, 51Cr and 177Lu, among others, and (f) radiocontrast agents, for example, particles of tantalum, tungsten, rhenium, niobium, molybdenum, and their alloys, which metallic particles may be spherical or non-spherical. Additional examples of radiocontrast agents include non-ionic radiocontrast agents, such as iohexol, iodixanol, ioversol, iopamidol, ioxilan, or iopromide, ionic radiocontrast agents such as diatrizoate, iothalamate, metrizoate, or ioxaglate, and iodinated oils, including ethiodized poppyseed oil (available as Lipiodol®).

Examples of colorants include brilliant blue (e.g., Brilliant Blue FCF, also known as FD&C Blue 1), indigo carmine (also known as FD&C Blue 2), indigo carmine lake, FD&C Blue 1 lake, and methylene blue (also known as methylthioninium chloride), among others.

Examples of additional agents further include tonicity adjusting agents such as sugars (e.g., dextrose, lactose, etc.), polyhydric alcohols (e.g., glycerol, propylene glycol, mannitol, sorbitol, etc.) and inorganic salts (e.g., potassium chloride, sodium chloride, etc.), among others, suspension agents including various surfactants, wetting agents, and polymers (e.g., albumen, PEO, polyvinyl alcohol, block polymers, etc.), among others, and pH adjusting agents including various buffer solutes.

In various embodiments, a system is provided that includes one or more delivery devices for delivering first and second compositions to a subject.

In some embodiments, the system may include a delivery device that comprises a first reservoir that contains a first fluid composition that comprises an iodinated polyamide compound as described herein and a second reservoir that contains a second fluid composition that comprises a reactive polymer as described herein, wherein the first and second fluid compositions form a crosslinked product upon mixing. In some embodiments, the system may include a delivery device that comprises a first reservoir that contains a first fluid composition that comprises the iodinated polyamide compound and the reactive polymer and is buffered to an acidic pH, such as the prepared fluid composition previously described, and a second reservoir that contains second fluid composition, such as the fluid accelerant composition previously described.

In either case, during operation, the first fluid composition and second fluid composition are dispensed from the first and second reservoirs and combined, whereupon the iodinated polyamide compound and the reactive polymer and crosslinks with one another to form a crosslinked hydrogel.

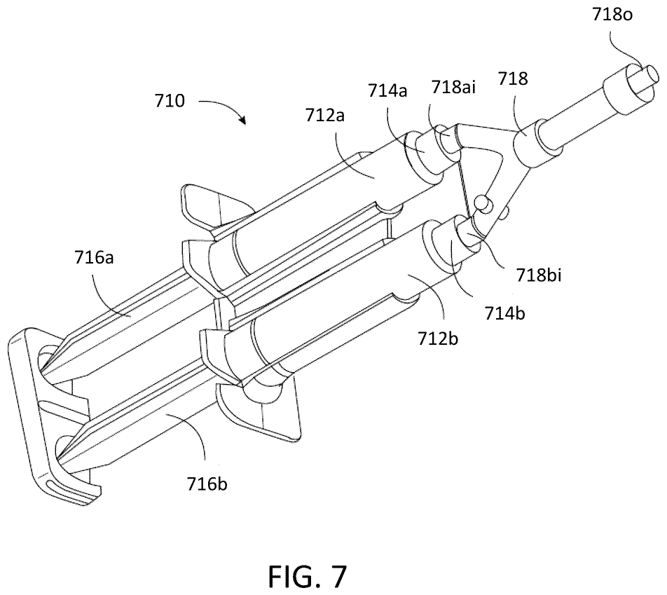

In particular embodiments, and with reference to FIG. 7, the system may include a delivery device 710 that comprises a double-barrel syringe, which includes a first barrel 712a having a first barrel outlet 714a, which first barrel contains the first composition, a first plunger 716a that is movable in the first barrel 712a, a second barrel 712b having a second barrel outlet 714b, which second barrel 712b contains the second composition, and a second plunger 716b that is movable in the second barrel 712b. In some embodiments, the device 710 may further comprise a mixing section 718 having a first mixing section inlet 718ai in fluid communication with the first barrel outlet 714a, a second mixing section inlet 718bi in fluid communication with the second barrel outlet, and a mixing section outlet 7180.

In some embodiments, the delivery device may further comprise a cannula or catheter tube that is configured to receive first and second fluid compositions from the first and second barrels. For example, a cannula or catheter tube may be configured to form a fluid connection with an outlet of a mixing section by attaching the cannula or catheter tube to an outlet of the mixing section, for example, via a suitable fluid connector such as a luer connector.

As another example, the catheter may be a multi-lumen catheter that comprises a first lumen and a second lumen, a proximal end of the first lumen configured to form a fluid connection with the first barrel outlet and a proximal end of the second lumen configured to form a fluid connection with the second barrel outlet. In some embodiments, the multi-lumen catheter may comprise a mixing section having a first mixing section inlet in fluid communication with a distal end of the first lumen, a second mixing section inlet in fluid communication with a distal end of the second lumen, and a mixing section outlet.

During operation, when the first and second plungers are depressed, the first and second fluid compositions are dispensed from the first and second barrels, whereupon the first and second fluid compositions mix and ultimately crosslink to form a crosslinked hydrogel, which is administered onto or into tissue of a subject. For example, the first and second fluid compositions may pass from the first and second barrels, into the mixing section via first and second mixing section inlets, whereupon the first and second fluid compositions are mixed to form an admixture, which admixture exits the mixing section via the mixing section outlet. In some embodiments, a cannula or catheter tube is attached to the mixing section outlet, allowing the admixture to be administered to a subject after passing through the cannula or catheter tube.

As another example, the first fluid composition may pass from the first barrel outlet into a first lumen of a multi-lumen catheter and the second fluid composition may pass from the second barrel outlet into a second lumen of the multi-lumen catheter. In some embodiments the first and second fluid compositions may pass from the first and second lumen into a mixing section at a distal end of the multi-lumen catheter via first and second mixing section inlets, respectively, whereupon the first and second fluid compositions are mixed in the mixing section to form an admixture, which admixture exits the mixing section via the mixing section outlet.

Regardless of the type of device that is used to mix the first and second fluid compositions or how the first and second fluid compositions are mixed, immediately after an admixture of the first and second fluid compositions is formed, the admixture is initially in a fluid state and can be administered to a subject (e.g., a mammal, particularly, a human) by a variety of techniques. Alternatively, the first and second fluid compositions may be administered to a subject independently and a fluid admixture of the first and second fluid compositions formed in or on the subject. In either approach, a fluid admixture of the first and second fluid compositions is formed and used for various medical procedures

For example, the first and second fluid compositions or a fluid admixture thereof can be injected to provide spacing between tissues, the first and second fluid compositions or a fluid admixture thereof can be injected (e.g., in the form of blebs) to provide fiducial markers, the first and second fluid compositions or a fluid admixture thereof can be injected for tissue augmentation or regeneration, the first and second fluid compositions or a fluid admixture thereof can be injected as a filler or replacement for soft tissue, the first and second fluid compositions or a fluid admixture thereof can be injected to provide mechanical support for compromised tissue, the first and second fluid compositions or a fluid admixture thereof be injected as a scaffold, and/or the first and second fluid compositions or a fluid admixture thereof can be injected as a carrier of therapeutic agents in the treatment of diseases and cancers and the repair and regeneration of tissue, among other uses.

After administration of the compositions of the present disclosure (either separately as first and second fluid compositions that mix in vivo or as a fluid admixture of the first and second fluid compositions) a crosslinked hydrogel is ultimately formed at the administration location.

After administration, the compositions of the present disclosure can be imaged using a suitable imaging technique. Typically, the imaging techniques is an x-ray-based imaging technique, such as computerized tomography or x-ray fluoroscopy, or a near near-IR fluorescence spectrometry-based technique.

As seen from the above, the compositions of the present disclosure may be used in a variety of medical procedures, including the following, among others: a procedure to implant a fiducial marker comprising a crosslinked product of the first and second fluid compositions, a procedure to implant a tissue regeneration scaffold comprising a crosslinked product of the first and second fluid compositions, a procedure to implant a tissue support comprising a crosslinked product of the first and second fluid compositions, a procedure to implant a tissue bulking agent comprising a crosslinked product of the first and second fluid compositions, a procedure to implant a therapeutic-agent-releasing depot comprising a crosslinked product of the first and second fluid compositions, a tissue augmentation procedure comprising implanting a crosslinked product of the first and second fluid compositions, a procedure to introduce a crosslinked product of the first and second fluid compositions between a first tissue and a second tissue to space the first tissue from the second tissue.

The first and second fluid compositions, fluid admixtures of the first and second fluid compositions, or the crosslinked products of the first and second fluid compositions may be injected in conjunction with a variety of medical procedures including the following: injection between the prostate or vagina and the rectum for spacing in radiation therapy for rectal cancer, injection between the rectum and the prostate for spacing in radiation therapy for prostate cancer, subcutaneous injection for palliative treatment of prostate cancer, transurethral or submucosal injection for female stress urinary incontinence, intra-vesical injection for urinary incontinence, uterine cavity injection for Asherman's syndrome, submucosal injection for anal incontinence, percutaneous injection for heart failure, intra-myocardial injection for heart failure and dilated cardiomyopathy, trans-endocardial injection for myocardial infarction, intra-articular injection for osteoarthritis, spinal injection for spinal fusion, and spine, oral-maxillofacial and orthopedic trauma surgeries, spinal injection for posterolateral lumbar spinal fusion, intra-discal injection for degenerative disc disease, injection between pancreas and duodenum for imaging of pancreatic adenocarcinoma, resection bed injection for imaging of oropharyngeal cancer, injection around circumference of tumor bed for imaging of bladder carcinoma, submucosal injection for gastroenterological tumor and polyps, visceral pleura injection for lung biopsy, kidney injection for type 2 diabetes and chronic kidney disease, renal cortex injection for chronic kidney disease from congenital anomalies of kidney and urinary tract, intravitreal injection for neovascular age-related macular degeneration, intra-tympanic injection for sensorineural hearing loss, dermis injection for correction of wrinkles, creases and folds, signs of facial fat loss, volume loss, shallow to deep contour deficiencies, correction of depressed cutaneous scars, perioral rhytids, lip augmentation, facial lipoatrophy, stimulation of natural collagen production.

Where formed ex vivo, crosslinked hydrogels may be in any desired form, including a slab, a cylinder, a coating, or a particle. In some embodiments, the crosslinked hydrogel is dried and then granulated into particles of suitable size. Granulating may be by any suitable process, for instance by grinding (including cryogrinding), homogenization, crushing, milling, pounding, or the like. Sieving or other known techniques can be used to classify and fractionate the particles. Crosslinked hydrogel particles formed using the above and other techniques may vary widely in size, for example, having an average size ranging from 50 to 950 microns.

In addition to a crosslinked hydrogel as described above, crosslinked hydrogel compositions in accordance with the present disclosure may contain additional agents, including therapeutic agents, imaging agents, colorants, tonicity adjusting agents, suspension agents, wetting agents, and pH adjusting agents as described above.

In various embodiments, kits are provided that include one or more delivery devices for delivering the crosslinked hydrogel composition to a subject. Such systems may include one or more of the following: a syringe barrel, which may or may not contain a crosslinked hydrogel composition as described herein; a vial, which may or may not contain a crosslinked hydrogel composition as described here; a needle; a flexible tube (e.g., adapted to fluidly connect the needle to the syringe); and an injectable liquid such as water for injection, normal saline or phosphate buffered saline. Whether supplied in a syringe, vial, or other reservoir, the crosslinked hydrogel composition may be provided in dry form (e.g., powder form) or in a form that is ready for injection, such as an injectable hydrogel form (e.g., a suspension of crosslinked hydrogel particles).

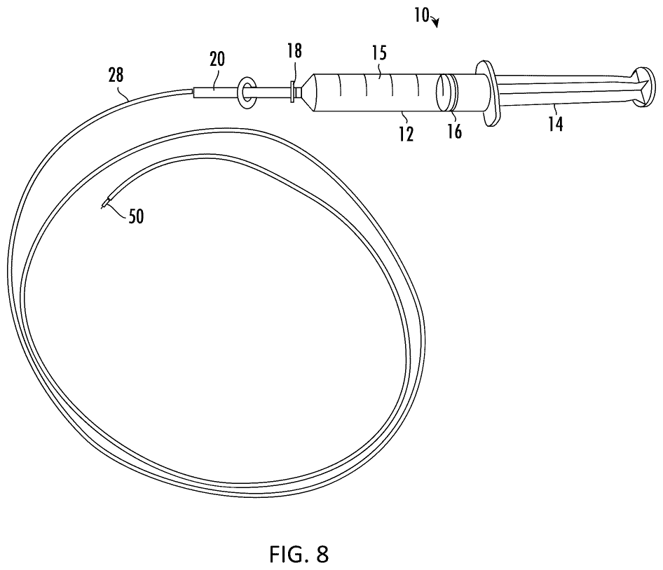

FIG. 8 illustrates a syringe 10 providing a reservoir for a crosslinked hydrogel compositions as discussed above. The syringe 10 may comprise a barrel 12, a plunger 14, and one or more stoppers 16. The barrel 12 may include a Luer adapter (or other suitable adapter/connector), e.g., at the distal end 18 of the barrel 12, for attachment to an injection needle 50 via a flexible catheter 29. The proximal end of the catheter 29 may include a suitable connection 20 for receiving the barrel 12. In other examples, the barrel 12 may be directly coupled to the injection needle 50. The syringe barrel 12 may serve as a reservoir, containing a crosslinked hydrogel composition 15 for injection through the needle 50. The crosslinked hydrogel compositions described herein can be used for a number of purposes including those described herein. For instance, crosslinked hydrogel compositions in accordance with the present disclosure include lubricious compositions for medical applications, compositions for therapeutic agent release (e.g., by including one or more therapeutic agents in a matrix of the crosslinked hydrogel), and implants (which may be formed ex vivo or in vivo) (e.g., compositions for use as tissue markers, compositions that act as spacers to reduce side effects of off-target radiation therapy, cosmetic compositions, etc.). After administration, the crosslinked hydrogel compositions of the present disclosure can be imaged using a suitable imaging technique, as described herein.

What is claimed is:

1. A method comprising (a) performing a ring-opening polymerization of one or more types of iodinated amino acid N-carboxyanhydride (NCA) monomers that comprise at least one type of iodinated amino acid NCA monomer having at least one iodinated group and at least one aromatic amine substitute in the presence of an iodinated initiator compound to produce intermediate iodinated compounds that comprise an amino acid chain having iodine groups, hydroxyl groups, and pendant amine groups covalently attached to a residue of the iodinated initiator compound and (b) converting at least some of the hydroxyl groups to amine groups or reacting amine groups of the intermediate iodinated compounds with an amine containing moiety to form final iodinated polyamide compounds that comprise an amino acid chain having iodine groups and pendant amine groups covalently attached to the residue of the iodinated initiator compound.

2. The method of claim 1, wherein the at least one iodinated group further comprises at least one iodinated aromatic group.

3. The method of claim 1, wherein a molar ratio of the iodinated amino acid NCA monomer to the iodinated initiator compound ranges from 2:1 to 100:1.

4. The method of claim 1, wherein the amino acid chain ranges from 2 to 50 amino acid in length.

5. The method of claim 1, wherein the pendant amine groups are a protected primary amine groups.

6. The method of claim 1, wherein the pendant amine groups are protected alkylamine groups.

7. The method of claim 1, wherein the iodinated amino acid NCA monomer includes iodinated aromatic groups.

8. The method of claim 1, further comprising reacting an iodinated amino acid with a phosgene or a phosgene derivative to form the iodinated amino acid NCA monomer.

9. The method of claim 8, wherein the iodinated amino acid is 3-Iodo-L-tyrosine, Triiodothyronine, Thyroxine, Diiodothyronine, 4-Iodo-L-phenylalanine, 3,5-Diiodotyrosine, 4-Iodo-D-phenylalanine, 3,3′-Diiodo-L-thyronine, 3′,5′,3-Triiodothyronine, or any combination thereof.

10. The method of claim 8, wherein the iodinated amino acid is formed by iodinating an amino acid NCA monomer.

11. The method of claim 1, wherein the iodinated initiator compound comprises a primary amine group or an aliphatic hydroxyl group.

12. The method of claim 1, wherein the iodinated initiator compound comprises (a) a primary amine group or an aliphatic group and (b) an iodinated aromatic group.

13. The method of claim 1, wherein the iodinated initiator compound comprises an iodinated amino acid ester.

14. The method of claim 1, wherein the one or more types of iodinated amino acid NCA monomers comprise a single type of iodinated amino acid NCA monomer.

15. The method of claim 1, wherein the hydroxyl groups and the iodine groups of the iodinated polyamide compounds comprise aromatic hydroxyl groups and iodinated aromatic groups.

16. A method comprising (a) forming iodinated amino acid N-carboxyanhydride (NCA) monomers by reacting an iodinated amino acid with a phosgene or phosgene derivative to form the iodinated amino acid NCA monomer, (b) performing a ring-opening polymerization of one or more types of iodinated amino acid NCA monomers that comprise at least one type of iodinated amino acid NCA monomer having at least one iodinated group and at least one aromatic amine substitute in the presence of an iodinated initiator compound to produce intermediate iodinated compounds that comprise an amino acid chain having iodine groups, hydroxyl groups, and pendant amine groups covalently attached to a residue of the iodinated initiator compound and (c) converting at least some of the hydroxyl groups to amine groups or reacting amine groups of the intermediate iodinated compounds with an amine containing moiety to form final iodinated polyamide compounds that comprise an amino acid chain having iodine groups, hydroxyl groups, and pendant amine groups covalently attached to the residue of the iodinated initiator compound.

17. The method of claim 16, further comprising ethoxylating at least some of the hydroxyl groups of the iodinated polyamide compounds to form iodinated multi-arm hydrophilic polymers.

18. The method of claim 16, wherein the iodinated multi-arm hydrophilic polymers include at least one iodinated aromatic group per arm.

19. A method of iodinating a crosslinked hydrogel, the method comprising:
forming a crosslinked hydrogel having a plurality of nucleophilic groups; and
performing ring-opening polymerization of an iodinated amino acid N-carboxyanhydride (NCA) monomer having at least one iodinated group and at least one aromatic amine substitute in the presence of the cross-linked hydrogel to form an iodinated crosslinked hydrogel having iodine groups and pendant amine groups covalently attached to the residue of the iodinated amino acid NCA monomer.

20. The method of claim 19, further comprising functionalizing the cross-linked hydrogel with an amine group and subsequently performing the ring-opening polymerization.
